(19) United States
(12) Patent Application Publication
(10) Pub. No.: US 2025/0075139 A1
(43) Pub. Date: Mar. 6, 2025

(54) System and process for producing synthetic fuels without emitting carbon dioxide

(71) Applicant: EDL Anlagenbau Gesellschaft mbH, Leipzig (DE)

(72) Inventors: Rolf Gambert, Grimma (DE); Michael Haid, Ratingen (DE); Jan Schwartze, Leipzig (DE)

(73) Assignee: EDL Anlagenbau Gesellschaft mbH, Leipzig (DE)

(21) Appl. No.: 18/555,300

(22) PCT Filed: Apr. 14, 2022
(86) PCT No.: PCT/EP2022/060101

§ 371 Date: Oct. 13, 2023

(30) Foreign Application Priority Data
Apr. 22, 2021 (EP) 21169997.0

(51) Int. Cl. C10L 1/08; C01B 3/40; C02F 1/20; C02F 1/42; C02F 3/28; C02F 9/00; C10J 1/20; C25B 15/08

(52) U.S. Cl. CPC C10L 1/08; C01B 3/40; C02F 9/00; C10J 1/20; C25B 15/081; C25B 15/085; C01B 2203/0233; C01B 2203/0238; C01B 2203/0475; C01B 2203/062; C01B 2203/0827; C01B 2203/1241; C01B 2203/141; C01B 2203/148; C02F 1/20; C02F 2001/422; C02F 2001/425; C02F 3/28; C10L 2270/026; C10L 2270/04; C10L 2290/42

(57) ABSTRACT

A plant for the production of synthetic fuels, in particular jet fuel (kerosene), crude petrol and/or diesel, includes:
a) a synthesis gas production unit for the production of a raw synthesis gas from methane, water and carbon dioxide, the synthesis gas production unit having at least one reaction section in which methane, water and carbon dioxide react to form the raw synthesis gas, and at least one heat generation section in which the heat necessary for the reaction of methane and carbon dioxide to produce the raw synthesis gas is generated by burning fuel to form flue gas,
b) a separation unit for separating carbon dioxide from the raw synthesis gas produced in the synthesis gas production unit,
c) a Fischer-Tropsch unit for the production of hydrocarbons by a Fischer-Tropsch process from the synthesis gas from which carbon dioxide has been separated in the separation unit, and
d) a refining unit for refining the hydrocarbons produced in the Fischer-Tropsch unit into synthetic fuels,
   the plant further comprising e ₁₎ a separation unit for separating carbon dioxide from the flue gas discharged from the synthesis gas production unit via the flue gas discharge line and/or e ₂₎ a flue gas return line which is connected to the heat generation section of the synthesis gas production unit, wherein i) the carbon dioxide separated from flue gas or the flue gas itself via the flue gas return line and ii) the carbon dioxide separated from the raw synthesis gas are either fed directly to the synthesis gas production unit or first fed to a carbon dioxide compression unit and from there fed to the synthesis gas production unit, with the unit also having an electrolysis unit for separating water into hydrogen and oxygen, wherein the electrolysis unit has a water feed line, an oxygen discharge line and a hydrogen discharge line, and wherein from the oxygen discharge line a line leads into the oxygen-containing gas feed line to the synthesis gas production unit.

The present invention relates to a plant and a process for producing synthetic fuels, in particular jet fuel, diesel and/or crude petrol.

There are a number of different processes for producing fuels, for example jet fuel, diesel, crude petrol or the like. Such processes are mainly based on the processing of fossil raw materials, for example the refining of crude oil, the liquefaction of coal or the synthesis of fuels from natural gas, water and oxygen. The synthesis of fuels from natural gas, water and oxygen is also known as the “gas-to-liquids” process. In this process, a synthesis gas comprising hydrogen and carbon monoxide is first produced from natural gas, water and oxygen, which is then converted in a Fischer-Tropsch synthesis to hydrocarbons, which consist primarily of long-chain normal paraffins. These hydrocarbons are then converted to synthetic fuels by cracking and isomerization.

A similar process is the conversion of electrical energy into synthetic fuels, known as “power-to-liquids”. For this purpose, water and carbon dioxide are converted into synthesis gas, which is then processed into synthetic fuels in a similar way to the “gas-to-liquids” process.

An alternative process known as “power and biomass-to-liquids” uses biomass for example biomethane and biogas or synthetic methane as a carbon source in addition to carbon dioxide from the air or from point sources, thereby completely replacing fossil carbon sources for example petroleum or natural gas. For example, in such a process, methane, water (vapor) and carbon dioxide are converted into synthesis gas, which is then further processed into synthetic fuels in a manner similar to the processes mentioned above.

A major disadvantage of the above processes is that significant amounts of carbon dioxide are generated and emitted. However, this is undesirable for environmental reasons and in particular for climate protection reasons. In addition, these processes require larger amounts of fresh water and generate large amounts of wastewater. However, water of the required purity is an expensive raw material and large amounts of wastewater are problematic for environmental reasons.

Starting from this, the present invention was based on the object of providing a plant and a process for the production of synthetic fuels, which(s) can be operated with low power consumptions without carbon dioxide emissions or, if any, with minimal carbon dioxide emissions, which only requires a small amount of fresh water supply and can be operated with small amounts of wastewater, and which can still be operated at least almost exclusively with electrical energy and biomass.

According to the invention, this object is achieved by a plant according to claim 1 and in particular by a plant for the production of synthetic fuels, in particular jet turbine fuel, diesel and/or crude petrol, which comprises:
a) a (first) synthesis gas production unit for producing a raw synthesis gas comprising carbon monoxide, hydrogen and carbon dioxide from methane, water and carbon dioxide, the synthesis gas production unit having at least one reaction section in which methane, water and carbon dioxide react to form the raw synthesis gas, and at least one heat generation section, in which the heat required for the reaction of methane and carbon dioxide to form the raw synthesis gas is generated by burning fuel to form flue gas, the reaction section comprising a feed line for methane, a feed line for water, at least one feed line for carbon dioxide and a discharge line for raw synthesis gas, and the heat generation section comprises a feed line for fuel, a feed line for oxygen-containing gas and a discharge line for flue gas,
b) a separation unit for separating carbon dioxide from the raw synthesis gas produced in the synthesis gas production unit with a discharge line for carbon dioxide and a discharge line for synthesis gas,
c) a Fischer-Tropsch unit for the production of hydrocarbons by a Fischer-Tropsch process from the synthesis gas from which carbon dioxide has been separated in the separation unit, and
d) a refining unit for refining the hydrocarbons produced in the Fischer-Tropsch unit into synthetic fuels, the unit further comprising:
e ₁₎ a separation unit for separating carbon dioxide from the flue gas discharged from the synthesis gas production unit via the discharge line for flue gas, the separation unit having a discharge line for carbon dioxide, wherein the discharge line for carbon dioxide from the separation unit for separating carbon dioxide from the gas discharged via the flue gas discharge line, the flue gas discharged from the synthesis gas production unit and the discharge line for carbon dioxide from the separation unit for separating carbon dioxide from the raw synthesis gas produced in the synthesis gas production unit are either connected directly to one of the at least one feed lines for carbon dioxide into the synthesis gas production unit, or the discharge line for carbon dioxide from the separation unit for separating carbon dioxide from the flue gas discharged via the discharge line for flue gas from the synthesis gas production unit and the carbon dioxide discharge line of the separator for separating carbon dioxide from the raw synthesis gas produced in the synthesis gas production unit are connected to a carbon dioxide compression unit which has a discharge line that is connected to one of the at least one feed line for carbon dioxide of the synthesis gas production unit, and/or
e ₂₎ a flue gas return line connected to the flue gas discharge line of the synthesis gas production unit, the flue gas return line and the carbon dioxide discharge line of the separation unit for separating carbon dioxide from the raw synthesis gas produced in the synthesis gas production unit being connected either directly to one of the at least one carbon dioxide feed lines of the synthesis gas production unit or the flue gas return line and the discharge line for carbon dioxide of the separation unit for separating carbon dioxide from the raw synthesis gas produced in the synthesis gas production unit being connected to a carbon dioxide compression unit which has a discharge line which is connected to one of the at least one feed lines for carbon dioxide of the synthesis gas production unit,
   wherein the plant further comprises an electrolysis unit for separating water into hydrogen and oxygen, wherein the electrolysis unit has a water feed line, an oxygen discharge line and a hydrogen discharge line, and wherein a line leads from the oxygen discharge line into the feed line for oxygen-containing gas into the synthesis gas production unit.

By separating not only the carbon dioxide remaining in the reaction product of the synthesis gas production unit, i.e. in the raw synthesis gas, in the plant according to the invention and in the process according to the invention and returning it to the synthesis gas production unit, but also that generated by combustion in the synthesis gas production unit-to provide the heat necessary for the strongly endothermic reaction, the flue gas is either completely returned to the synthesis gas production unit and/or the carbon dioxide contained therein is separated from the flue gas and then the separated carbon dioxide is returned to the synthesis gas production unit, all of the carbon dioxide in the process is utilized and carbon dioxide emissions are reliably avoided. In addition, according to the invention, at least part of the requirement for oxygen-containing gas for burning the fuel in the heat generation section of the synthesis gas production unit is covered by oxygen produced in the electrolysis unit. In this way, the proportion of air used as combustion gas can be significantly reduced or even reduced to zero, namely by the oxygen produced by the electrolysis of water, which is operated exclusively with electrical energy. Due to the reduced amount of air in the mixture of fuel, oxygen and air, the gas volume to be heated to the combustion temperature in the heat generation section of the synthesis gas production unit is significantly reduced because the nitrogen content (about 79% of the air) in the air fraction is replaced by the oxygen originating from electrolysis. This leads to a reduction in the fuel requirement, because significantly lower heat outputs have to be provided for the same reaction enthalpy, and thus to a reduction in the power consumption of the plant. In addition, this leads to a reduction in the volume of carbon dioxide-containing flue gas that is produced during combustion. This not only reduces the amount of carbon dioxide that has to be circulated via the flue gas, meaning that the cooling capacity for the flue gas can also be significantly reduced, but in particular also increases the hydrogen-to-carbon monoxide ratio in the raw synthesis gas. As a result, the amount of hydrogen to be fed to the synthesis gas production unit to set the desired hydrogen-to-carbon monoxide ratio in the raw synthesis gas, which hydrogen is preferably also produced in the electrolysis unit, is reduced. Thus, according to the invention, a significant part of the oxygen-containing gas required to burn the fuel in the heat generation section of the synthesis gas production unit and preferably also the hydrogen required to set the desired hydrogen-to-carbon monoxide ratio in the raw synthesis gas is produced solely by electrical energy produced by electrolysis of water. In principle, it is now possible to provide all of the oxygen containing gas required for burning the fuel in the heat generation section of the synthesis gas production unit solely with oxygen from the electrolysis unit, although in large-scale plants for safety reasons the synthesis gas production unit may also be provided with a certain proportion of air or another suitable gas, for example carbon dioxide, so that the oxygen content of the combustion mixture and thus the combustion temperature is not too high. A further particular advantage of the plant according to the invention and the process according to the invention is that the water required for the electrolysis can be produced from the wastewater produced when the process according to the invention is carried out in the plant according to the invention, as is explained further below in relation to particularly preferred embodiments of the present invention, and as a result the use of fresh water can be dispensed with completely or at least insofar as possible. Apart from that, the plant according to the invention and the process according to the invention will allow the amount of unused off-gases and wastewater to be significantly reduced, since the process gases and wastewater produced can be and are reused in the individual parts of the plant, for example in the electrolysis unit. In particular, biomethane or synthetic methane produced from green input materials is used as methane, and green electricity in particular is used as electrical energy.

As an alternative to biomethane, methane from any other source can also be used, and in particular any methane-containing gas mixture, for example biogas, can be used which preferably contains 30 to 70% by volume of methane and 70 to 30% by volume of carbon dioxide and particularly preferably 40 to 60% by volume vol. % methane and 60 to 40 vol. % carbon dioxide, for example about 50 vol. % methane and about 50 vol. % carbon dioxide. Consequently, the process according to the invention conserves resources, since natural and fossil-based raw materials for example crude oil, natural gas and the like are not required. Overall, the present invention enables the complete conversion of methane, carbon dioxide formed during the process and water to be converted, by means of electrical energy to synthetic fuels via fully integrated process units while avoiding any carbon dioxide emissions, without significant continuous amounts of off-gas and at most a minimized wastewater output, to synthetic fuels for example jet fuel, diesel and/or crude petrol, for example kerosene (SAF—“Sustainable Aviation Fuel”), crude petrol and/or mineral spirits. Finally, the process according to the invention is characterized by a comparatively low power consumption. All of this is achieved through the synergistic interaction of the electrolysis unit and the flue gas treatment in accordance with plant features e ₁₎ and e ₂₎.

According to the invention, the separation unit b) is designed to separate carbon dioxide from the raw synthesis gas produced in the synthesis gas production unit, the Fischer-Tropsch unit c) is designed to produce hydrocarbons by a Fischer-Tropsch process from the synthesis gas from which carbon dioxide was separated in the separation unit b), and the refining unit d) is designed for refining the hydrocarbons produced in the Fischer-Tropsch unit c) to the synthetic fuels. This means that the separation unit b) for separating carbon dioxide is connected to the synthesis gas production unit a) via the discharge line for raw synthesis gas of the synthesis gas production unit a), the Fischer-Tropsch unit c) for the production of hydrocarbons by a Fischer-Tropsch process is connected to the separator b) is connected via a synthesis gas feed line and refining unit d) is connected to the Fischer-Tropsch unit d) via a hydrocarbon feed line.

As explained above, the core of the present invention is the synergistic interaction of the flue gas treatment according to the plant features e ₁₎ or e ₂₎ and the electrolysis unit. For this it is essential to separate all the carbon dioxide that is produced during the operation of the plant according to the invention or during the implementation of the process according to the invention and to return it to the synthesis gas production unit, i.e. not only to remove the carbon dioxide remaining in the reaction product of the synthesis gas production unit, i.e. in the raw synthesis gas, but in particular and above all also the flue gas produced in the synthesis gas production unit, to provide the heat required for the strongly endothermic reaction by combustion, either returning it completely to the synthesis gas production unit and/or separating the carbon dioxide contained therein from the flue gas and then returning the separated carbon dioxide to the synthesis gas production unit. It is therefore very particularly preferred according to the present invention that the plant does not have a carbon dioxide discharge line and that no carbon dioxide is discharged during operation of the plant. The process according to the invention therefore very particularly preferably has a completely neutral carbon dioxide balance.

An essential part of the plant according to the invention is the synthesis gas production unit b) for the production of a carbon monoxide, hydrogen and carbon dioxide-comprising raw synthesis gas made from methane, water and carbon dioxide. In this context, production of a raw synthesis gas comprising carbon monoxide, hydrogen and carbon dioxide from methane, water and carbon dioxide means that the starting gas mixture contains methane, water and carbon dioxide, but can also contain other components. In particular, biogas which contains 30 to 70% by volume of methane and 70 to 30% by volume of carbon dioxide and preferably 40 to 60% by volume of methane and 60 to 40% by volume of carbon dioxide, for example 50% by volume methane and about 50% by volume carbon dioxide, can be used as a methane source. The feed line for methane accordingly designates a feed line for a methane-containing gas, which can be biogas or pure methane, for example. The synthesis gas production unit b) is preferably a dry reformer. The dry reformer preferably contains a nickel oxide catalyst and can be operated at a pressure of from 10 to 50 bar and a temperature of from 700 to 1,200° C. In addition to methane and steam, a dry reformer can also process carbon dioxide, with these reactions being very strongly endothermic. Therefore, the dry reformer requires appropriate heating in order to provide the energy or heat required for the endothermic reaction, which according to the invention is preferably achieved by burning fuel with an oxygen-containing gas, which is oxygen from the electrolysis and possibly air or another suitable gas is composed is achieved. According to a particularly preferred embodiment of the present invention, it is intended for the fuel required for this purpose to be provided completely or at least almost completely by off-gases or combustible gases and synthetic fuel generated during operation of the plant, i.e. to manage without or at least almost without external fuel. The methane fed to the dry reformer can be freed from sulfur-containing impurities beforehand, for example in a hydrogenation plant using hydrogen.

For this purpose, it is proposed in a further development of the inventive idea that the Fischer-Tropsch unit or the refining unit and particularly preferably the Fischer-Tropsch unit and the refining unit each have a gas discharge line which is/are connected to the feed line for fuel of the synthesis gas production unit in order to use the off-gases formed in the Fischer-Tropsch reaction and refining, which have a calorific value, as fuel or combustible gas for heating the synthesis gas production unit.

In addition, it is preferred that the refining unit has one or more synthetic fuel product discharge lines, wherein at least one of the one or more synthetic fuel product discharge lines is connected via a return line to the fuel feed line of the synthesis gas production unit, so that part of the synthetic fuel produced in the refining unit, for example mineral spirits in particular, can be conducted as fuel into the heat generation section of the synthesis gas production unit. Thus, if the off-gases generated in the Fischer-Tropsch unit and in the refining unit do not have a sufficient overall calorific value to generate the heat required for the operation of the synthesis gas production unit when they are burned, the required residual amount of energy or heat can be generated by supplying a corresponding amount of synthetic fuel produced in the plant, for example mineral spirits in particular, in order to be able to dispense with the supply of external fuel.

For example, the refining unit may have a kerosene (SAF) product discharge line, a crude petrol product discharge line, and a mineral spirits product discharge line, with the return line leading from one or more of these product discharge lines, preferably the mineral spirits product discharge line, into the synthesis gas production unit fuel feed line.

According to a further preferred embodiment of the present invention, it is provided that the plant comprises a control unit which controls the amount of synthetic fuel fed into the heat generation section of the synthesis gas production unit as fuel in such a way that no external fuel has to be supplied to the synthesis gas production unit and preferably to the entire plant.

In a further development of the present invention, it is proposed that the synthesis gas production unit, which is preferably designed as a dry reformer, comprises one or more tube bundle reactors, with the tubes of each tube bundle reactor forming the reaction section and the area outside the tubes forming the heat generation section. As a result, the educts methane, steam and carbon dioxide can be heated quickly, evenly and effectively to the temperature required for generating the raw synthesis gas in a structurally simple manner. One or more suitable nickel oxide catalysts, for example SYNSPIRE™ G1-110 (BASF catalyst), are placed in the tubes. During the operation of the plant, the educts in the tubes of the dry reformer are heated by the combustion of the fuel in the heat generation section of the dry reformer, preferably at 10 to 50 bar, particularly preferably 20 to 40 bar, for example about 30 bar, to 700 to 1,200° C., particularly preferably 800 to 1100° C., more preferably 900 to 950° C., for example about 930° C. The conversion of the carbon dioxide in the dry reformer with methane and steam reaches only a maximum of 50% in practice, even under optimal conditions, so that the carbon dioxide concentration in the raw synthesis gas produced is about 30% by volume. This comparatively high concentration of carbon dioxide would heavily burden the Fischer-Tropsch synthesis, in which carbon dioxide is an inert gas, and the carbon dioxide would be returned to the dry reformer as part of the off-gas after the Fischer-Tropsch synthesis with the off-gas of the Fischer-Tropsch unit, where it would reduce combustion efficiency and enter the flue gas. In order to avoid all the associated disadvantages, the carbon dioxide is separated from the raw synthesis gas in the plant according to the invention in the separation unit b).

Hydrogen is required for the iso-hydrocracker reactor preferably contained in the refining unit and for the hydrogen stripper preferably also contained therein. For this purpose, it is proposed in a further development of the concept of the invention that hydrogen generated in the electrolysis unit be used for this purpose. Therefore, a line preferably leads from the hydrogen discharge line of the electrolysis unit to the Fischer-Tropsch unit and/or a line to the refining unit. Preferably, a line leads from the hydrogen discharge line of the electrolysis unit to the Fischer-Tropsch unit and a line to the refining unit and preferably also a line to the synthesis gas compression unit.

Preferably, the electrolysis unit comprises one or more solid oxide electrolysis cells, one or more polymer electrolyte membrane electrolysis cells and/or one or more alkaline electrolysis cells. For example, hydrogen is produced by alkaline low-temperature, high-pressure water electrolysis.

According to the invention, the synthesis gas production unit comprises a hydrogen feed line which is preferably connected to the hydrogen discharge line of the electrolysis unit. As a result, hydrogen can be supplied to the synthesis gas production unit during operation of the plant according to the invention and the H ₂/CO molar ratio of the raw synthesis gas produced in the synthesis gas production unit can thereby be adjusted. For this reason, it is also preferred in this embodiment that the plant comprises a control unit which controls the amount of hydrogen fed into the synthesis gas production unit so that the H ₂/CO molar ratio in the raw synthesis gas produced in the synthesis gas production unit is 1.13 to 1.80 and preferably 1.15 to 1.50 for example 1.17, 1.39 or 1.43. Typically, the dry reformer operates with a H ₂/CO molar ratio of about 1.13. With a larger H ₂/CO molar ratio, however, the carbon dioxide requirement of the dry reformer decreases. In order to balance the amount of carbon dioxide present from separating the carbon dioxide from the flue gas and from the raw synthesis gas against the necessary requirement, it is preferred according to the invention to set the molar ratio (H ₂/CO) to the amount of CO ₂ separated off.

According to a particularly preferred embodiment of the present invention, it is provided that the plant includes a complete water demineralization unit in which fresh water is demineralized and degassed in such a way that the water produced has a sufficiently high purity for the electrolysis of water. The complete water demineralization unit therefore preferably comprises a fresh water feed line and/or preferably a feed line for wastewater generated in the plant, which has particularly preferably previously been purified of hydrocarbons, and a discharge line for demineralized water, the discharge line for demineralized water being connected to the water feed line of the electrolysis unit. Particular preference is given to all of the fresh water or all or at least almost all of it, i.e., preferably more than 50% by weight, particularly preferably more than 80% by weight, very particularly preferably more than 90% by weight and most preferably all of the process water produced in the plant, which has particularly preferably been purified beforehand, is fed to the water demineralization unit. Good results are achieved in particular if the demineralization unit is designed in such a way that the fresh water supplied is demineralized and degassed to such an extent that its conductivity is less than 20 μS/cm, preferably less than 10 μS/cm, particularly preferably less than 5 μS/cm and most preferably at most 2 μS/cm. For this purpose, the demineralization unit preferably has one or more anion and cation exchangers and a membrane unit for degassing. During degassing, carbon dioxide and oxygen are removed from the water. The regeneration of the initial and cation exchangers is preferably carried out using caustic soda or hydrochloric acid. The resulting wastewater has about 6 times the ion concentration of the water before it is fed into the demineralization unit and can be fed to a municipal wastewater plant as neutral wastewater due to the simultaneous regeneration of the initial and cation exchanger.

In a development of the idea of the invention, it is proposed that the plant includes a water purification unit in which the process water accumulated in the plant is purified in such a way that it can be circulated. This reduces the fresh water requirement of the plant to a minimum. In this embodiment, the plant preferably has a water feed line leading from the refining unit to the water purification unit and/or a water feed line leading from the Fischer-Tropsch unit to the water purification unit and/or a water feed line leading from the synthesis gas production unit to the water purification unit and/or a water feed line leading from the carbon dioxide compression unit to the water purification unit water feed line respectively for purifying process water accruing therein. In this embodiment, the plant preferably has a water feed line leading from the refining unit to the water purification unit and a water feed line leading from the Fischer-Tropsch unit to the water purification unit and a water feed line leading from the synthesis gas production unit to the water purification unit and preferably also a water feed line leading from the carbon dioxide compression unit to the water purification unit respectively for purifying process water accruing therein.

The water purification unit can, for example, have one or more steam stripping units, in which at least 95% of all hydrocarbons can be removed by steam stripping.

According to a particularly preferred embodiment of the present invention, the water purification unit comprises an anaerobic reactor. In an anaerobic water purification reactor, the water to be purified is brought into contact with anaerobic microorganisms, which break down the organic impurities contained in the water primarily into carbon dioxide and methane. In contrast to aerobic water purification, anaerobic water purification does not require oxygen to be introduced into the bioreactor, which would require a great deal of energy. Depending on the type and form of the biomass used, the reactors for anaerobic water purification are divided into contact sludge reactors, UASB reactors, EGSB reactors, fixed bed reactors and fluidized bed reactors. While the microorganisms in fixed bed reactors adhere to stationary carrier materials and the microorganisms in fluidized bed reactors adhere to small, freely moving carrier material, the microorganisms in UASB and EGSB reactors are used in the form of so-called pellets. A particular advantage of using an anaerobic reactor as a water purification unit in the plant according to the invention is that the process wastewater from the Fischer-Tropsch synthesis contains a wide variety of hydrocarbons, for example alcohols, aldehydes, carboxylic acids and the like, which cannot be removed via other water purification processes, for example a steam stripper. Consequently, the water purification by an anaerobic reactor allows the water to be purified in such a way that it can be used in the plant, possibly after demineralization in the preferred water demineralization unit, for example in the electrolysis unit. In addition, the water purified and demineralized/degassed in this way can be used as boiler storage water. This drastically reduces the need for fresh water, or even no fresh water may be needed at all. Finally, the biogas formed in the anaerobic reactor of the water purification unit, which consists primarily of carbon dioxide and methane, can be routed via a gas return line from the water purification unit to the heat generation section of the synthesis gas production unit, where it acts as a fuel.

The water purification unit is preferably connected to the water demineralization unit via a line, so that water purified in the water purification unit can be fed into the water demineralization unit. In this way, the amount of demineralized and degassed water can be flexibly adapted to the needs, especially for the electrolysis unit.

According to a further, particularly preferred embodiment of the present invention, the water purification unit is connected directly or indirectly to the water feed line of the synthesis gas production unit in order to be able to supply purified process water as educt to the synthesis gas production unit.

In this embodiment of the present invention, an evaporation unit is preferably connected downstream of the water purification unit, with the evaporation unit being connected to the water purification unit via a line and to the water feed line of the synthesis gas production unit for supplying water in the form of steam to the synthesis gas production unit.

In addition, it is preferred that the plant comprises a control unit which controls the amount of water purified in the water purification unit fed into the reaction section of the synthesis gas production unit in such a way that no fresh water has to be fed to the synthesis gas production unit. This contributes to minimizing the fresh water requirement when operating the plant according to the invention.

In a further development of the idea of the invention, it is proposed that the plant according to the invention also has a methane steam reformer as a second synthesis gas production unit for producing a raw synthesis gas comprising hydrogen and carbon monoxide from methane, water and hydrogen. The methane steam reformer is preferably connected in parallel to the (first) synthesis gas production unit, which is particularly preferably designed as a dry reformer, with the raw synthesis gases produced in the two synthesis gas production units being mixed with one another before the raw synthesis gas mixture produced in this way is sent to the separation unit for separating carbon dioxide from the raw synthesis gas. An advantage of this embodiment is that the methane steam reformer yields raw synthesis gas with a higher H₂/CO molar ratio than the dry reformer. Consequently, the raw synthesis gas mixture of the raw synthesis gas generated in the dry reformer and the raw synthesis gas generated in the methane steam reformer has a higher H₂/CO molar ratio than the raw synthesis gas generated in the dry reformer, so that in this embodiment with the combined use of a dry reformer and a methane steam reformer requires less hydrogen or no hydrogen from the electrolysis unit to set the desired H₂/CO molar ratio in the raw synthesis gas fed to the separation unit than when the dry reformer is used alone. The methane steam reformer preferably has a hydrogen feed line, a methane feed line, a water (steam) feed line, a discharge line for raw synthesis gas and a discharge line for water, the hydrogen feed line being connected to the hydrogen discharge line of the electrolysis unit, the discharge line for raw synthesis gas being connected to the discharge line for raw synthesis gas is connected to the (first) synthesis gas production unit and preferably the discharge line for water is connected to the water purification unit.

The methane steam reformer is preferably completely electrically heated solely by means of induction, i.e. no carbon dioxide is emitted as a result of the inductive heating of the methane steam reformer. Preferably, the methane steam reformer is operable at low to moderate pressures of 1 to 20 bar, for example 10 to 15 bar, and reaction temperatures of up to 1500° C., for example 1000 to 1200° C., to achieve a high yield of synthesis gas (H ₂/CO) with the lowest possible carbon dioxide content. The carbon dioxide quantities from the heating of the dry reformer and from the process of the methane steam reformer are completely returned to the dry reformer, so that a completely carbon dioxide emission-free plant operation is possible. In order to absorb these amounts of carbon dioxide and to achieve the best possible H ₂/CO ratio of about 2 before the Fischer-Tropsch synthesis, a ratio between the dry reformer and the methane steam reformer of 30 to 60% to 40 to 65%, based on the methane input, is preferred, with an H ₂/CO ratio in the raw synthesis gas produced in the dry reformer of 1.13 to 1.80 and preferably from 1.15 to 1.20, for example 1.17, and an H ₂/CO ratio in the raw synthesis gas produced in the methane steam reformer from 3.20 to 3.60, for example 3.43. The ratio between the dry reformer and the methane-steam reformer is preferably adjusted via the amount of methane added to the methane-steam reformer, the H₂/CO ratio in the dry reformer being adjusted via the amount of carbon dioxide supplied and the H ₂/CO ratio in the methane steam reformer being adjusted via the amount of steam supplied.

To separate the carbon dioxide from the raw synthesis gas, it is proposed in a development of the inventive idea that the corresponding separation unit b) has an amine scrubber for separating carbon dioxide from the raw synthesis gas by absorption. In the amine scrubber, carbon dioxide is separated from the raw synthesis gas by absorption with at least one absorbent, which preferably consists of an amine compound for example monoethanolamine and/or diglycolamine and water, and then is returned directly or indirectly (e.g. via a desorber and a compressor) back to the synthesis gas production unit.

Good results are achieved in particular if the separation unit b) is followed by a compression unit for compressing the synthesis gas to the pressure required in the Fischer-Tropsch synthesis, the compression unit being connected to the separation unit via a line and to the Fischer-Tropsch unit via a Synthesis gas feed line is connected. In the preferred compressor, the remaining synthesis gas is compressed to the pressure required in the Fischer-Tropsch synthesis before the synthesis gas thus compressed is fed to the Fischer-Tropsch unit. The synthesis gas fed to the Fischer-Tropsch unit preferably contains 80 to 90% by mass of carbon monoxide and 10 to 15% by mass of hydrogen.

Hydrogen is preferably fed to the compression unit in order to adjust the H ₂/CO molar ratio of the synthesis gas fed to the Fischer-Tropsch unit to an optimum value. For this purpose, the compression unit preferably has a hydrogen feed line which is connected to the electrolysis unit. For example, the synthesis gas is compressed in the compression unit to 30 to 60 bar, preferably 40 to 50 bar, for example about 45 bar, and adjusted to a temperature of 100 to 140° C., preferably 110 to 130° C., for example about 120° C. After the compression unit, the synthesis gas is preferably also purified by means of adsorbents in a 3-stage process for removing halogen, oxygen and sulfur compounds in the ppb range, which act as catalyst poisons for the Fischer-Tropsch synthesis. The purification takes place in three consecutive stages for the halogen, oxygen and sulfur separation in appropriate fixed-bed reactors. An activated carbon bed serves as an additional safety filter. The synthesis gas is fed to the fine purifying plant at a pressure of approx. 45 bar and a temperature of approx. 120° C. An alumina/sodium oxide adsorbent acts as a halogen scavenger. The synthesis gas freed from halogen is further heated under temperature control to the operating temperatures of the downstream reactors of 140 to 150° C. This heating takes place by applying medium-pressure steam to the synthesis gas preheater. An alumina/palladium oxide adsorbent is used in the oxygen purge reactor and acts as an oxygen scavenger. The synthesis gas, which is still contaminated with traces of sulfur compounds, flows through different adsorbent layers in the sulfur purge reactor, namely first a layer with a zinc oxide/aluminum oxide/sodium oxide adsorbent, in which the main desulfurization takes place, and then a further safety layer with zinc oxide/copper oxide adsorbent, in which any residual sulfur that may be present is bound. An additional activated carbon bed serves as an additional filter for further impurities.

In order to set the optimum H ₂/CO molar ratio of the synthesis gas fed to the Fischer-Tropsch unit, it is preferred that the plant comprises a control unit which controls the amount of hydrogen fed into the compression unit in such a way that the H ₂/CO molar ratio in the synthesis gas discharged from the compression unit, which is fed to the Fischer-Tropsch unit via the synthesis gas feed line, is more than 2.0.

The synthesis gas is then converted into hydrocarbons in the Fischer-Tropsch unit. The Fischer-Tropsch synthesis is preferably carried out in a reactor with a catalyst at a temperature of from 170 to 270° C., preferably from 190 to 250° C. and most preferably from 210 to 230° C., for example 220° C. Particularly suitable catalysts are those selected from the group consisting of cobalt catalysts, for example preferably Co/MMT (montmorillonite) or Co/SiO ₂. The Fischer-Tropsch synthesis is preferably carried out in one or more tube bundle apparatus, with the catalyst being located in the tubes, whereas the cooling medium, preferably boiler feed water, is conveyed in the jacket space. The Fischer-Tropsch unit preferably comprises one or two reactors in order to be able to carry out the Fischer-Tropsch synthesis in one or two stages. For reasons of cost, the Fischer-Tropsch synthesis is preferably carried out in one stage. For example, the Fischer-Tropsch synthesis is carried out at a pressure of 25 to 35 bar or preferably also at a higher pressure of, for example, 45 bar. The higher the pressure, the smaller the reactors can be built. The Fischer-Tropsch synthesis is preferably carried out in such a way that a carbon monoxide conversion of 92% or more is achieved. In the Fischer-Tropsch synthesis, condensates and waxes are obtained as liquid products, which are fed to the downstream refining unit. The cooling of the very highly exothermic process of the Fischer-Tropsch synthesis takes place via boiler feed water, which is conducted via a corresponding line from the water demineralization unit and/or the water purification unit and preferably from the water demineralization unit into the Fischer-Tropsch unit and is evaporated to cool the reactors. At least a large part of the vapor produced in the Fischer-Tropsch synthesis is preferably fed via a steam return line to the synthesis gas production unit. The excess steam from the Fischer-Tropsch unit is preferably used for heating in the other plant units, so that no external steam is required.

In the refining unit, the products of the Fischer-Tropsch synthesis are refined into synthetic fuels, in particular aircraft turbine fuel (kerosene), diesel and/or crude petrol, for example kerosene (SAF—“Sustainable Aviation Fuel”), crude petrol and/or mineral spirits. For the production of industrially usable kerosene, diesel and crude petrol, it is necessary to convert the paraffinic product of the Fischer-Tropsch synthesis by hydro-isomerization and hydrocracking (iso-hydrocracking) in such a way that a high-quality jet fuel with the required cold properties (preferably with a temperature limit of the filterability according to “Cold Filtration Plugging Point” (CFPP) of maximum −40° C.) is produced. The heavy products are recirculated in the iso-hydrocracker reactor in such a way that only kerosene and crude petrol are formed as products. The resulting light gases are routed as fuel to the heat generation section of the synthesis gas production unit.

Therefore, it is preferred that the refining unit comprises one or more iso-hydrocracker reactors, preferably with a noble metal catalyst, for example preferably a platinum or palladium catalyst. Particularly preferred are noble metal catalysts that do not require sulfidation, as this avoids contamination of the reaction products with sulfur-containing components, which in turn allows the process gas produced during iso-hydrocracking, as well as the steam produced, to be recycled to the heat generation section of the synthesis gas production unit. Iso-hydrocracking is a catalytic reaction in which, in particular, long-chain paraffinic hydrocarbons are converted into short-chain isomers with improved cold properties for the production of kerosene. The catalytic reaction preferably takes place in bed reactors which are cooled with hydrogen to ensure the maximum bed temperature. For example, these are operated at a pressure of at least 70 bar.

Furthermore, it is preferred that the refining unit includes one or more hydrogen strippers for separating light hydrocarbons (namely C ₁- to C ₄ hydrocarbons). Finally, the refining unit preferably comprises one or more distillation columns for separating the synthetic fuels into individual fractions for example jet fuel and diesel, jet fuel and crude petrol, jet fuel, crude petrol and diesel, or the like.

The hydrogen required for the operation of the iso-hydrocracker reactor and for the hydrogen stripper is fed to the refining unit, as described above, preferably from the electrolysis unit.

As described above, it is preferred for the process water generated during the Fischer-Tropsch synthesis, which has a high proportion of hydrocarbons, for example in particular alcohols, aldehydes, carboxylic acids, etc., with a chemical oxygen demand (COD) of approx. 40,000 mg/I, to be conveyed to the water purification unit, where it is purified so that it can be circulated as process water.

In a development of the idea of the invention, it is proposed that the plant according to the invention also includes a methanation unit for converting carbon dioxide and hydrogen into methane and water. The methanation unit preferably has a carbon dioxide feed line, a hydrogen feed line, which is preferably connected to the hydrogen discharge line of the electrolysis unit, a methane discharge line and a water discharge line, the methane discharge line being connected to the methane feed line of the synthesis gas production unit and preferably the water discharge line of the methanation unit being connected to the water purification unit. A sub-line can also lead from the methane discharge line into the fuel feed line in the synthesis gas production unit. Since both the carbon dioxide and the hydrogen are produced when the plant is operated, in this embodiment the methane required for the (first) synthesis gas production unit, which is particularly preferably a dry reformer, can be produced inexpensively in the plant itself and does not have to be supplied from an external source. The reaction is very highly exothermic and also produces significant amounts of low and medium pressure steam, which can be used in the plant. Due to the existing electrolysis unit, the plant concept according to the invention makes it possible to integrate a methanation unit into the plant without any problems, especially since the water produced during the methanation can be purified in the preferred water treatment unit and thus demineralized in the preferred full demineralization unit and thus reused as starting material in the electrolysis or as boiler feed water. The methanation unit is preferably a tube bundle reactor equipped with a nickel catalyst.

According to a first preferred embodiment of the present invention, the plant has a separation unit e ₁₎ for separating carbon dioxide from the flue gas discharged from the synthesis gas production unit via the discharge line for flue gas. The separation unit preferably comprises an amine scrubber for separating carbon dioxide from the flue gas, with carbon dioxide being separated from the raw synthesis gas in the amine scrubber by absorption with at least one absorbent, which preferably consists of one or more amine compounds. The carbon dioxide separated off in this way can be fed directly to the synthesis gas production unit. However, it is preferred that the carbon dioxide separated in this way from the separation unit—particularly preferably together with the carbon dioxide separated from the raw synthesis gas in the separation unit b)—is first fed via a corresponding line to a carbon dioxide compression unit, in which the carbon dioxide is compressed to a pressure of 25 to 40 bar and preferably from 30 to 35 bar before the carbon dioxide gas thus compressed is recycled to the synthesis gas production unit.

According to a second preferred inventive embodiment of the present invention, all of the flue gas generated in the synthesis gas production unit is returned—directly or indirectly—to the synthesis gas production unit. This embodiment is particularly useful when the heat generation section of the synthesis gas production unit is supplied exclusively or at least primarily with oxygen from the electrolysis via the feed line for oxygen-containing gas, so that the flue gas does not contain any inert gases, for example nitrogen in particular, as is the case would be if air would be supplied for the. In this embodiment, the plant preferably has a flue gas return line connected to the flue gas discharge line of the synthesis gas production unit, wherein the flue gas return line—and particularly preferably also the carbon dioxide discharge line of the separation unit b) for separating carbon dioxide from the raw synthesis gas produced in the synthesis gas production unit is connected—either directly to one of the at least one feed lines for carbon dioxide of the synthesis gas production unit, or both lines are first fed to a carbon dioxide compression unit in which the carbon dioxide is compressed to the pressure previously described as preferred before the carbon dioxide gas compressed in this way is returned to the synthesis gas production unit.

According to a third preferred embodiment of the present invention, the two aforementioned embodiments are combined, i.e. part of the flue gas is fed into a separation unit for separating carbon dioxide, in which the carbon dioxide is separated from the flue gas, whereas the rest of the flue gas without carbon dioxide separation together with the carbon dioxide separated off in the two separation units is returned directly to the synthesis gas production unit or is first fed to a carbon dioxide compression unit in which the gas mixture is compressed to the pressure previously described as preferred before the gas mixture compressed in this way is returned to the synthesis gas production unit. This embodiment is also particularly useful when the heat generation section of the synthesis gas production unit is supplied exclusively or at least primarily with oxygen from the electrolysis via the feed line for oxygen-containing gas, so that the flue gas does not contain any inert gases, for example nitrogen in particular, as would be the case if air were supplied for that.

Another object of the present patent application is a process for producing synthetic fuels, in particular jet turbine fuel (kerosene), crude petrol and/or diesel, which is carried out in a previously described plant.

As explained above, the process according to the invention can be operated without removing carbon dioxide and/or without emission of carbon dioxide. For this reason it is preferred that no carbon dioxide is discharged in the process.

In a further development of the inventive, it is proposed that gas generated in the Fischer-Tropsch unit, gas generated in the refining unit and part of the synthetic fuels produced in the refining unit are fed as fuel into the heat generation section of the synthesis gas production unit, with the process preferably being controlled in such a way that no external fuel has to be or is supplied to the synthesis gas production unit and preferably to the entire plant.

According to the invention, the plant includes an electrolysis unit for separating water into hydrogen and oxygen. According to the present invention, at least part of the oxygen generated in the electrolyzer is sent to the heat generating section of the synthesis gas production unit via the oxygen-containing gas line. In addition, at least part of the hydrogen produced in the electrolysis unit can be fed to the reaction section of the synthesis gas production unit for desulfurization of the biomethane and in particular also for adjusting the H ₂/CO molar ratio in the raw synthesis gas produced in the reaction section in the synthesis gas production unit. Preferably, the H2/CO molar ratio in the raw synthesis gas produced in the synthesis gas production unit is adjusted to 1.13 to 1.80 and preferably 1.15 to 1.50, for example 1.17, 1.39 and 1.43.

Good results are obtained in particular if the separation unit b) is followed by a compression unit for compressing the gas to the pressure required in the Fischer-Tropsch synthesis, with the compression unit being supplied with part of the hydrogen produced in the electrolysis unit, with the amount of in hydrogen passed through the compressor controlled such that the H ₂/CO molar ratio in the synthesis gas discharged from the compressor and fed to the Fischer-Tropsch unit is greater than 2.0.

In the process according to the invention, part of the hydrogen produced in the electrolysis unit of the Fischer-Tropsch unit for generating the required H ₂/CO ratio of more than 2.0 in the Fischer-Tropsch unit, part of the hydrogen produced in the electrolysis unit is fed to the refining unit and part of the hydrogen produced in the electrolysis unit is fed to the synthesis gas compression unit.

In order to reduce the amount of combustion air required for the synthesis gas production unit as far as possible, it is provided according to the invention that at least part of the oxygen produced during the electrolysis is fed into the synthesis gas production unit. Preferably 1 to 90% by volume, preferably 5 to 60% by volume, particularly preferably 10 to 50% by volume, very particularly preferably 20 to 40% by volume and most preferably 25 to 35% by volume of the oxygen required in the synthesis gas production unit is conducted from the electrolysis unit into the synthesis gas production unit. The remainder of the oxygen required in the synthesis gas production unit is preferably supplied to the synthesis gas production unit in the form of air. As further explained above, in large-scale applications it is not possible for the oxygen content of the combustion mixture to be higher.

In addition, it is preferred that the plant comprises a water purification unit to which water produced therein by the refining unit, water produced therein by the Fischer-Tropsch unit, and water from the synthesis gas production unit is supplied, the amount of water purified in the water purification unit being so controlled that this is at least sufficient to cover the entire water requirement of the synthesis gas production unit. The water purification particularly preferably comprises at least one purification stage in an anaerobic reactor. The biogas formed in the anaerobic reactor of the water purification unit, which consists primarily of carbon dioxide and methane, can be conducted via a gas return line from the water purification unit into the heat generation section of the synthesis gas production unit in order to function as fuel in the heat generation section of the synthesis gas production unit.

Furthermore, it is preferred that the process is carried out in a plant which includes a complete water demineralization unit in which fresh water is demineralized and degassed in such a way that the water produced has a sufficiently high purity for the electrolysis of water. In the process according to the invention, the water in the demineralization unit is preferably purified to water with a conductivity of less than 20 μS/cm, preferably less than 10 μS/cm, particularly preferably less than 5 μS/cm and most preferably at most 2 μS/cm.

In a development of the invention, it is proposed that dry reforming be carried out in the synthesis gas production unit, in which a nickel oxide catalyst is used. In addition, it is preferred that the dry reforming is operated at a pressure of from 10 to 50 bar and a temperature of from 700 to 1200° C.

According to a particularly preferred embodiment of the present invention, the process also includes methane steam reforming. In the methane steam reforming, a raw synthesis gas comprising hydrogen and carbon monoxide is preferably produced from methane, water and hydrogen, with water (steam), methane and hydrogen being supplied from the electrolysis unit to the methane steam reformer and raw synthesis gas and water being discharged from the methane steam reformer, wherein the raw synthesis gas is fed to the separation unit and preferably the water is fed to the water purification unit. The methane steam reforming is preferably carried out at a pressure of 1 to 20 bar, preferably 5 to 15 bar and particularly preferably 10 to 15 bar and at a temperature of 800 to 150° C., preferably 900 to 1300° C. and particularly preferably 1000 to 1200° C., for example at a pressure of about 12 bar and a temperature of about 1100° C. The basic reaction is strongly endothermic, but the formation of CO ₂ cannot be completely ruled out. A nickel catalyst is preferably used for the methane steam reforming and the methane supplied to the methane steam reforming is hydrogenated in an upstream hydrogenation to remove the sulfur components with hydrogen, which preferably originates from the electrolysis unit, the hydrogenated sulfur components then being separated from the methane. In the methane steam reformer, the synthesis gas is preferably cooled by feedstock preheating and subsequent intermediate pressure steam generation. All of the steam produced can be used as steam for the methane steam reformer in conjunction with the medium pressure steam from the dry reformer.

Good results are obtained in particular when dry reforming is carried out in the process in the synthesis gas production unit and the ratio between the dry reformer and the methane steam reformer is adjusted to 30 to 60% to 40 to 65%, based on the methane input. Furthermore, it is preferred if in the raw synthesis gas produced in the dry reformer there is an H2/CO ratio of 1.13 to 1.80 and preferably 1.15 to 1.20, for example 1.17, and the raw synthesis gas produced in the methane steam reformer has a H2/CO ratio of 3.20 to 3.60, for example 3.43.

It is also preferred that in the process carbon dioxide and hydrogen supplied from the electrolysis unit are converted into methane and water in a methanation unit, with the methane being supplied to the synthesis gas production unit and preferably the water being supplied to the water purification unit. A tube bundle reactor equipped with a nickel catalyst is preferably used as the methanation unit. The methanation preferably takes place under a pressure of 10 to 50 bar and more preferably 30 to 40 bar, for example at about 35 bar, and at a temperature of 100 to 500° C., preferably 200 to 400° C. and particularly preferably from 250 to 350° C., for example of about 300° C. The cooling of the very strongly exothermic reaction is preferably carried out by means of boiler feed water in the shell space of the tube bundle reactor by evaporation to generate low and medium pressure steam, which can be used in other parts of the plant. The carbon dioxide conversion in the methanation unit is 80 to 85%, so that carbon dioxide remains in the product, which, however, can be fed to the (first) synthesis gas production unit or the dry reformer without any problems.

In a further development of the idea of the invention, it is proposed that a purge gas stream is derived as fuel gas from the Fischer-Tropsch unit. This reliably prevents the accumulation of inert gases such as nitrogen and argon in the synthesis gas production unit and in the Fischer-Tropsch unit.

Finally, it is preferred that the refining unit produces jet fuel, crude petrol and/or diesel, and preferably both jet fuel and crude petrol. For example, in the process according to the invention, kerosene (SAF—“Sustainable Aviation Fuel”), crude petrol and mineral spirits are produced.

The present invention is described in more detail below with reference to the drawing, in which:

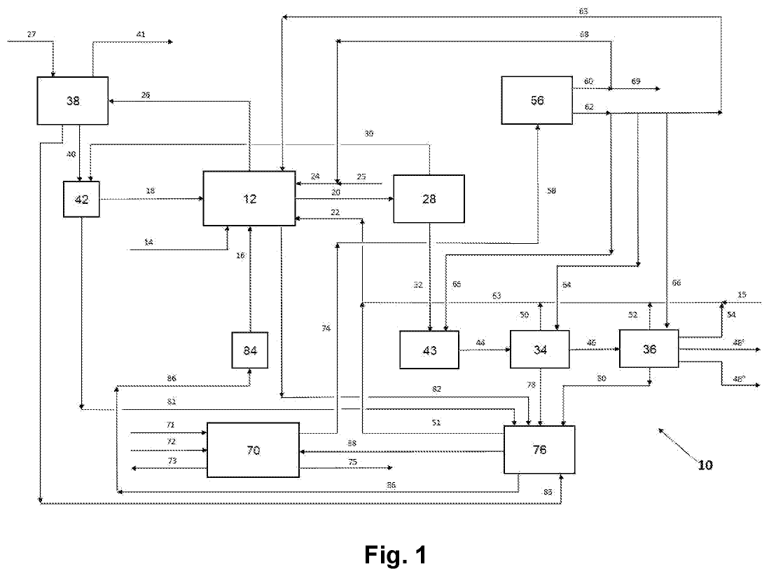

FIG. 1 shows a schematic view of a for the production of synthetic fuels according to an embodiment.

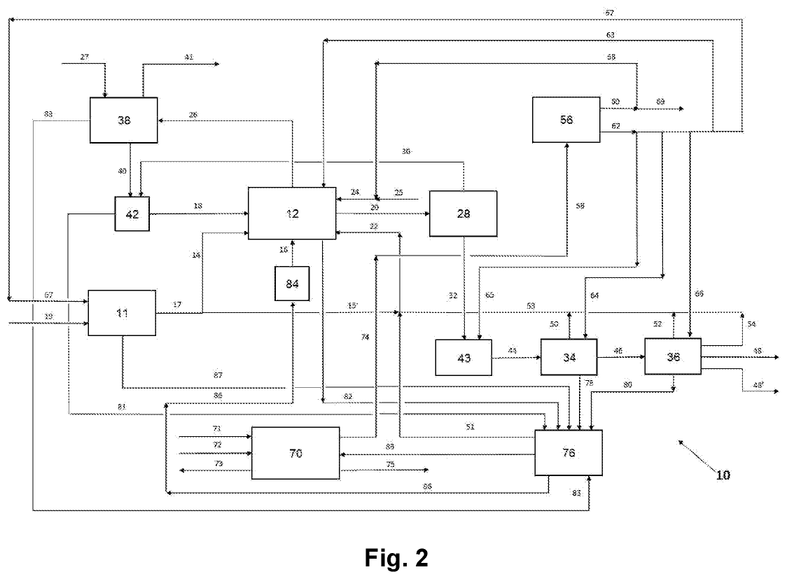

FIG. 2 shows a schematic view of a for the production of synthetic fuels according to another embodiment. FIG. 23

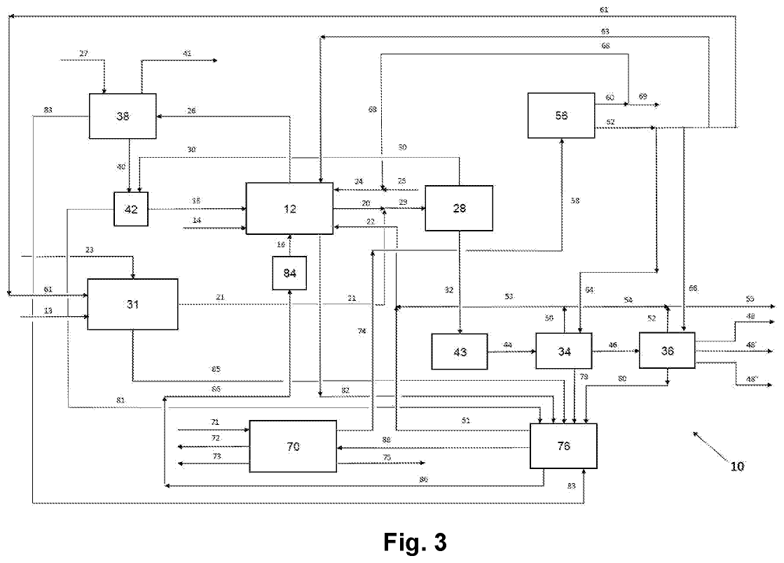

FIG. 3 shows a schematic view of a for the production of synthetic fuels according to a further embodiment.

The plant 10 shown in FIG. 1 for the production of synthetic fuels includes:
a) a synthesis gas production unit 12 for producing a raw synthesis gas comprising carbon monoxide, hydrogen and carbon dioxide from methane, water and carbon dioxide, the synthesis gas production unit 12 having at least one reaction section in which methane, water and carbon dioxide react to form the raw synthesis gas, and at least one heat generation section in which the heat required for the reaction of methane, water and carbon dioxide to form the raw synthesis gas is generated by burning fuel to form flue gas, the reaction section having a feed line 14 for methane, a feed line 16 for water, at least one feed line 18 for carbon dioxide and a discharge line 20 for raw synthesis gas and the heat generation section comprises a fuel feed line 22, an oxygen-containing gas feed line 24 and a flue gas discharge line 26,
b) a separation unit 28 for separating carbon dioxide from the raw synthesis gas produced in the synthesis gas production unit 12 with a discharge line 30 for carbon dioxide and a discharge line 32 for synthesis gas,
c) a Fischer-Tropsch unit 34 for the production of hydrocarbons by a Fischer-Tropsch process from the synthesis gas from which carbon dioxide was separated in the separation unit 28, and
d) a refining unit 36 for refining the hydrocarbons produced in the Fischer-Tropsch unit 34 into the synthetic fuels,
wherein the plant 10 further comprises:
e ₁₎ a separation unit 38 for separating carbon dioxide from the flue gas discharged from the synthesis gas production unit via the discharge line 26 for flue gas, the separation unit 38 having a discharge line 40 for carbon dioxide, the discharge line 40 for carbon dioxide belonging to the separation unit 38 for separating carbon dioxide from the flue gas discharged via discharge line 26 for flue gas from the synthesis gas production unit 12 and the discharge line 30 for carbon dioxide from separation unit 28 for separating carbon dioxide from the raw synthesis gas produced in synthesis gas production unit 12 are connected to a carbon dioxide compression unit 42, which has a discharge line that is connected to feed line 18 for carbon dioxide of the synthesis gas production unit 12.

The separation unit 28 is followed by a synthesis gas compression unit 43 for compressing the synthesis gas to the pressure required in the Fischer-Tropsch synthesis. The synthesis gas compression unit 43 is connected to the separation unit 28 via the discharge line 32 for synthesis gas and to the Fischer-Tropsch unit 34 via a synthesis gas feed line 44. The Fischer-Tropsch unit 34 in turn is connected to the refining unit 36 via the line 46, the refining unit 36 having two product discharge lines 48′, 48″.

A gas return line 50 leads from the Fischer-Tropsch unit 34, a methane feed line 15 leads from the outside and a gas return line 52, a fuel return line 54 and a biogas return line 51 lead from the refining unit 36 into the fuel feed line 22 of the synthesis gas production unit 12.

The plant 10 also includes an electrolysis unit 56 for generating hydrogen and oxygen from water, the electrolysis unit 56 having a water feed line 58, an oxygen discharge line 60 and a hydrogen discharge line 62. A line 63 leads from the hydrogen discharge line 62 to the synthesis gas production unit 12, a line 64 to the Fischer-Tropsch unit 34, a line 65 to the synthesis gas compression unit 43 and a line 66 to the refining unit 36. From the oxygen discharge line 60, an oxygen line 68 leads into the feed line 24 for oxygen-containing gas of the synthesis gas production unit 12 and an oxygen product line 69 from the plant 10. A feed line 25 for combustion air also leads into the feed line 24 for oxygen-containing gas of the synthesis gas production unit 12.

In addition, the plant 10 includes a water demineralization unit 70 which has a fresh water feed line 72 and a discharge line 74 for demineralized water, the discharge line 74 for demineralized water being connected to the water feed line 58 of the electrolysis unit 56.

In addition, the plant 10 includes a water purification unit 76, in which process water accruing in the plant is purified in such a way that it can be circulated. The water purification unit 76 includes an anaerobic reactor in which the water to be purified is brought into contact with anaerobic microorganisms, which break down the organic impurities contained in the water primarily into carbon dioxide and methane. A process water feed line 78 coming from the Fischer-Tropsch unit 34, a process water supply line 80 coming from the refining unit 36, a process water feed line 81 coming from the carbon dioxide compression unit 42 and a process water feed line 82 coming from the synthesis gas production unit 12 lead to the water purification unit 76. The plant 10 also includes an evaporation unit 84, the evaporation unit 84 being connected to the water purification unit 76 via a process water line 86. In addition, the evaporation unit 84 is connected to the feed line 16 for water vapor of the synthesis gas production unit 12 via a line. Finally, a process water line 88 leads from the water purification unit 76 to the water demineralization unit 70 and a biogas return line 51 leads to the heat generation section of the synthesis gas production unit 12 for the biogas formed in the anaerobic reactor of the water purification unit 76, which consists primarily of carbon dioxide and methane, for example in a ratio of approximately 1:1.

Finally, the separation unit 38 for separating off the flue gas from the plant 10 comprises a feed line 27 for boiler feed water, a discharge line 41 for nitrogen and a process water discharge line 83 which opens into the water purification unit 76. The water demineralization unit 70 also includes a feed line 71 for boiler condensate, a discharge line 73 for boiler feed water and a wastewater discharge line 75 from the plant 10.

During operation of the plant 10, the reaction section of the synthesis gas production unit 12 is supplied with methane via the feed line 14, water (steam) via the feed line 16 and carbon dioxide via the feed line 18, which react in the reaction section of the synthesis gas production unit 12 to form raw synthesis gas. The energy or heat necessary for this highly endothermic reaction is generated by burning fuel in the heat generation section of the synthesis gas production unit. For this purpose, fuel is fed to the heat generation section of the synthesis gas production unit 12 via the feed line 22 and an oxygen-containing gas is fed via the feed line 24. The fuel comes from off-gases or fuel produced in plant 10, namely from the off-gas from the Fischer-Tropsch unit 34, which is fed to the synthesis gas production unit 12 via the gas return line 50, from the off-gas from the refining unit 36, which is fed to the synthesis gas production unit 12 via the is fed to the gas return line 52, from synthetic fuel (mineral spirits) which is fed to the synthesis gas production unit 12 via the fuel return line 54, and from biogas which is fed to the synthesis gas production unit 12 via the biogas return line 51 from the water purification unit 76. The combustion of the fuel in the heat generation section of the synthesis gas production unit 12 takes place, for example, at 1.5 bar and a temperature of 1100° C. The raw synthesis gas generated in the reaction section of the synthesis gas production unit 12 is drawn off via the discharge line 20 and fed to the separation unit 28, whereas the flue gas produced by combustion in the heat generation section of the synthesis gas production unit 12 is drawn off via the discharge line 26 and fed to the separation unit 38. In the separation unit 28 carbon dioxide is separated from the raw synthesis gas, which is conducted via the line 30 into the carbon dioxide compression unit 42. In addition, carbon dioxide is separated from the flue gas in the separation unit 38 and is conducted via the line 40 into the carbon dioxide compression unit. In the carbon dioxide compression unit 42, the carbon dioxide is compressed to, for example, 32.5 bar before the compressed carbon dioxide is fed back to the synthesis gas production unit 12 via the line 18. Carbon dioxide emissions can be dispensed with as a result of this procedure, since the carbon dioxide produced by the combustion of the fuel is used to replace the carbon dioxide consumed in the synthesis gas production. For this reason, the process according to the invention is carbon dioxide-neutral. In addition, as a result of this procedure, the supplying of external fuel can be completely or at least almost completely dispensed with.

The synthesis gas freed from carbon dioxide in the separation unit 28 is fed via the line 32 to the synthesis gas compression unit 43, into which hydrogen is also fed from the electrolysis unit 56 via the line 65. In the compression unit, the synthesis gas is compressed to 42.5 bar, for example, and adjusted to a temperature of 120° C. Furthermore, after the compression unit, the synthesis gas is also purified with appropriate adsorbents, by means of which halogens, sulfur, nitrogen, oxygen, metals and other impurities are removed from the synthesis gas. The amount of hydrogen fed to the synthesis gas compressor 43 is controlled so that the H₂/CO molar ratio of the synthesis gas is greater than 2.0. This synthesis gas is fed via line 44 into the Fischer-Tropsch unit 34, in which the synthesis gas is converted into primarily normal-paraffinic hydrocarbons. These hydrocarbons are sent via line 46 to the refining unit 36, where they are hydro-isomerized and hydrocracked (iso-hydrocracked) to produce synthetic feedstocks which are then separated in the hydrogen stripper, and in the one or more distillation columns of refining unit 36 are separated into the fractions of mineral spirits, crude petrol and kerosene (SAF “Sustainable Aviation Fuel”), of which crude petrol and kerosene are discharged from the plant 10 via the lines 48 (crude petrol) and 48′ (kerosene) and from which mineral spirits is fed via the fuel return line 54 and finally via the fuel feed line 22 to the synthesis gas production unit 12. Water accruing in the Fischer-Tropsch unit 34, in the refining unit 36, in the carbon dioxide compression unit 42, in the separation unit 38 for carbon dioxide and in the synthesis gas production unit 12 is conducted via the process water lines 78, 80, 81, 82, 83 into the wastewater purification unit 76, in which the wastewater is purified by anaerobic microorganisms. A portion of the purified process water is fed via the process water line 86 to the evaporation unit 84, in which the process water is completely evaporated, with the water vapor thus generated being fed to the synthesis gas production unit 12 via the line 16. The other portion of the purified process water is fed to the complete water demineralization unit 70 via the process water line 88.

The pure water required for the electrolysis unit 56 is produced by the complete demineralization of fresh water and purified process water in the water demineralization unit 70 and is fed to the electrolysis unit 56 via the line 58. The hydrogen produced in the electrolysis unit 56 is fed to the synthesis gas production unit 12, the Fischer-Tropsch unit 34, the synthesis gas compression unit 43 and the refining unit 36 via the lines 62, 63, 64, 65, 66. A portion of the oxygen produced in the electrolyzer 56 is conducted via line 68 together with air supplied via line 25 as an oxygen-containing gas into the heat generating section of the synthesis gas production unit 12, while the other part of the oxygen produced in the electrolyzer 56 is discharged via line 69 from the Appendix 10 is discharged.

The plant 10 shown in FIG. 2 corresponds to that shown in FIG. 1, except that the plant 10 shown in FIG. 2 additionally includes a methanation unit 11 for converting hydrogen and carbon dioxide into methane and water. The methanation unit 11 has a carbon dioxide feed line 19, a hydrogen feed line 67, which is connected to the hydrogen discharge line 62 of the electrolysis unit 56, a methane discharge line 17 and a water discharge line 87, the methane discharge line 17 being connected to the methane feed line 14 of the synthesis gas production unit 12 and the water discharge line 87 of the methanation unit 11 being connected to the water purification unit 76. A sub-line 15′ also leads from the methane discharge line 17 22 into the feed line for fuel in the synthesis gas production unit 12. Since both the carbon dioxide and the hydrogen are produced when the plant 10 is in operation, in this embodiment the methane required for the (first) synthesis gas production unit 12, which is a dry reformer, can be produced inexpensively in the plant 10 itself and does not have to be supplied from an external source. The reaction is highly exothermic and also produces significant amounts of low- and medium-pressure steam, which can be used in the plant. Due to the existing electrolysis unit 56, the plant concept according to the invention makes it possible to integrate the methanation unit 11 into the plant 10 without any problems, especially since the water produced during the methanation can be purified in the water treatment unit 76 and thus completely demineralized in the full demineralization unit 70 and can thus be used as starting material in the electrolysis or can be reused as boiler feed water.

The plant 10 shown in FIG. 3 corresponds to that shown in FIG. 1, except that the plant 10 shown in FIG. 3 also has a methane steam reformer 31 as a second synthesis gas production unit for producing a carbon monoxide- and hydrogen-comprising raw synthesis gas from methane, water and hydrogen The methane steam reformer 31 is preferably connected in parallel to the (first) synthesis gas production unit 12, which is designed as a dry reformer, with the raw synthesis gases produced in the two synthesis gas production units 12, 31 being mixed with one another before the raw synthesis gas mixture produced in this way is sent to the separating unit 28 for separating off carbon dioxide is supplied from the raw synthesis gas. For this purpose, the methane steam reformer 31 has a hydrogen feed line 61, a methane feed line 13, a water (steam) feed line 23, a discharge line 21 for raw synthesis gas and a discharge line 85 for process water, with the hydrogen feed line 61 being connected to the hydrogen discharge line 62 of the electrolysis unit 56. the discharge line 21 for raw synthesis gas is connected to the discharge line 20 for raw synthesis gas of the (first) synthesis gas production unit 12 to the raw synthesis gas feed line 29 of the separation unit 28 and the discharge line 85 for water is connected to the water purification unit 76. The methane steam reformer 31 can be completely electrically heated solely by means of induction, i.e., no carbon dioxide is emitted as a result of the inductive heating of the methane steam reformer 31. The methane steam reformer is operated at low to moderate pressures of 1 to 20 bar, for example 10 to 15 bar, and reaction temperatures of up to 1500° C., for example 1000 to 1200° C. An advantage of this embodiment is that the methane steam reformer 31 produces a raw synthesis gas with a higher H ₂/CO molar ratio than the dry reformer 12. Consequently, the raw synthesis gas mixture of the raw synthesis gas generated in the dry reformer 12 and the raw synthesis gas generated in the methane steam reformer 31 has a higher H₂/CO molar ratio than the raw synthesis gas generated in the dry reformer 12, so that in this embodiment—compared to the sole use of the dry reformer 12, —with the combined use of a dry reformer 12 and a methane steam reformer 31, no hydrogen from the electrolysis unit 56 is required to set the desired H₂/CO molar ratio in the raw synthesis gas supplied to the separation unit 28. Finally, the plant 10 also includes a discharge line 55 for fuel gases.

The present invention is described below using an example that is illustrative but not limiting for the invention.

### EXAMPLE 1

The process according to the invention was simulated in a plant shown in FIG. 1 and described above with the process simulation software PRO/II (AVEVA) for the production of 144,456 liters per day of kerosene (SAF—“Sustainable Aviation Fuel”) and 42,528 liters per day of crude petrol. The following product flows were determined for the individual lines:

| | | | | Liquid |
|---|---|---|---|---|
| | | Total | Gas | Std. |
| No. | Name | kg/h | Nm³/h | m³/h |
| 14 | Methane feed line to the synthesis | 6,150 | 8,592 | |
| | gas production unit | | | |
| 15 | Methane feed line | 385 | 538 | |
| 16 | Steam feed line to the synthesis gas | 11,000 | 13,686 | |
| | production unit | | | |
| 18 | Carbon dioxide feed line to the synthesis | 21,260 | 10,839 | |
| | gas production unit | | | |
| 20 | Discharge line for raw synthesis gas | 29,699 | 38,172 | |
| 22 | Fuel feed line | 4,398 | 5,055 | |
| 24 | Oxygen-containing gas feed line | 44,232 | 34,100 | |
| 25 | Feed line for combustion air | 40,182 | 31,263 | |
| 26 | Flue gas discharge line | 48,630 | 38,690 | |
| 27 | Feed line for boiler feed water | 386 | | 0.39 |
| 30 | Discharge line for carbon dioxide | 11,108 | 5,632 | |
| | from the raw synthesis gas separation | | | |
| | unit | | | |
| 32 | Discharge line for synthesis gas | 18,591 | 32,445 | |
| 40 | Discharge line for carbon dioxide | 10,384 | 5,388 | |
| | from the flue gas separation unit | | | |
| 41 | Discharge line for nitrogen | 38,246 | 26,716 | |
| 44 | Synthesis gas feed line to the | 19,352 | 40,580 | |
| | Fischer-Tropsch unit | | | |
| 46 | Feed line to the refining unit | 6,210 | | 8.0 |
| 48 | Product discharge line crude petrol | 1,210 | | 1.77 |
| 48 | Product discharge line kerosene | 4,550 | | 6.06 |
| 50 | Gas return line of the Fischer-Tropsch | 3,373 | 4,167 | |
| | unit | | | |
| 51 | Biogas return line to the synthesis | 206 | 203 | |
| | gas production unit | | | |
| 52 | Gas return line of the refining unit | 88 | 39 | |
| 54 | Fuel return line | 346 | | 0.55 |
| 58 | Water feed line of the electrolysis | 7,499 | | 7.5 |
| | unit | | | |
| 60 | Oxygen discharge line of the electrolysis | 6,632 | 4,711 | |
| | unit | | | |
| 62 | Hydrogen discharge line of the electrolysis | 867 | 9,203 | |
| | unit | | | |
| 63 | Hydrogen feed line to the synthesis | 17.7 | 140 | |
| | gas production unit | | | |
| 64 | Hydrogen feed line to the Fischer- | 0 | 0 | |
| | Tropsch unit | | | |
| 65 | Hydrogen feed line to the carbon dioxide | 761 | 8,127 | |
| | compressor | | | |
| 66 | Hydrogen feed line to the refining | 88 | 937 | |
| | unit | | | |
| 68 | Oxygen line | 4,050 | 2,837 | |
| 69 | Oxygen product line | 2,582 | 1,809 | |
| 71 | Feed line for boiler condensates | 56,431 | | 56.5 |
| 72 | Fresh water supply pipe/water discharge | 3,494 | | 3.5 |
| | pipe | | | |
| 73 | Discharge line for boiler feed water | 59,490 | | 59.5 |
| 74 | Discharge line for demineralized water | 7,499 | | 7.5 |
| 75 | Discharge line for wastewater | 950 | | 0.96 |
| 78 | Process water discharge line from | 9,769 | | 9.8 |
| | the Fischer-Tropsch unit | | | |
| 80 | Process water discharge line from | 104 | | 0.10 |
| | the refining unit | | | |
| 81 | Process water discharge line the | 231 | | 0.23 |
| | from carbon dioxide compression | | | |
| | unit | | | |
| 82 | Process water discharge line from | 8,729 | | 8.74 |
| | the synthesis gas production unit | | | |
| 83 | Process water discharge line from | 386 | | 0.39 |
| | the separation unit for separating | | | |
| | carbon dioxide | | | |
| 86 | Process water feed line of the evaporation | 11,000 | | 11.0 |
| | unit from the water purification | | | |
| | unit | | | |
| 88 | Process water feed line of the water | 8,014 | | 8.0 |
| | demineralization unit from the water | | | |
| | purification unit | | | |

### EXAMPLE 2

The process according to the invention was simulated in a plant shown in FIG. 2 and described above with the process simulation software PRO/II (AVEVA) for the production of 145,827 liters per day of kerosene (SAF—“Sustainable Aviation Fuel”) and 42,883 liters per day of crude petrol. The following product flows were determined for the individual lines:

| | | | | Liquid |
|---|---|---|---|---|
| | | Total | Gas | Std. |
| No. | Name | kg/h | Nm³/h | m³/h |
| 14 | Methane feed line | 7,710 | 10,323 | |
| 15′ | Sub-line into the fuel feed line | 413 | 552 | |
| 16 | Steam feed line to the synthesis gas | 11,000 | 13,686 | |
| | production unit | | | |
| 17 | Methane product line of the | 8,122 | 10,875 | |
| | methanation unit | | | |
| 18 | Carbon dioxide feed line to the synthesis | 23,200 | 11,829 | |
| | gas production unit | | | |
| 19 | Carbon dioxide feed line to the | 18,094 | 9,284 | |
| | methanation unit | | | |
| 20 | Discharge line for raw synthesis gas | 31,856 | 38,994 | |
| 22 | Fuel feed line | 4461 | 5,110 | |
| 24 | Oxygen-containing gas feed line | 40,460 | 31,102 | |
| 25 | Feed line for combustion air | 35,560 | 27,670 | |
| 26 | Flue gas discharge line | 44,921 | 35,734 | |
| 27 | Feed line for boiler feed water | 386 | | 0.39 |
| 30 | Discharge line for carbon dioxide | 13,138 | 6,670 | |
| | from the raw synthesis gas separation | | | |
| | unit | | | |
| 32 | Discharge line for synthesis gas | 18,718 | 32,234 | |
| 40 | Discharge line for carbon dioxide | 10,326 | 5,358 | |
| | from the flue gas separation unit | | | |
| 41 | Discharge line for nitrogen | 34,595 | 23,690 | |
| 44 | Synthesis gas feed line to the | 19,539 | 41,006 | |
| | Fischer-Tropsch unit | | | |
| 46 | Feed line to the refining unit | 6,270 | | 8.1 |
| 48′ | Crude petrol product discharge line | 1,222 | | 1.78 |
| 48″ | Kerosene product discharge line | 4,593 | | 6.12 |
| 50 | Gas return line of the Fischer-Trop- | 3,406 | 4,210 | |
| | sch unit | | | |
| 51 | Biogas return line to the synthesis | 206 | 203 | |
| | gas production unit | | | |
| 52 | Refining unit gas return line | 88 | 39 | |
| 54 | Fuel return line | 349 | | 0.55 |
| 58 | Water feed line of the electrolysis | 35,696 | | 36.8 |
| | unit | | | |
| 60 | Oxygen discharge line of the electrolysis | 31,570 | 22,113 | |
| | unit | | | |
| 62 | Hydrogen discharge line of the electrolysis | 4,127 | 45,439 | |
| | unit | | | |
| 63 | Hydrogen feed line to the synthesis | 17.7 | 140 | |
| | gas production unit | | | |
| 64 | Hydrogen feed line to the Fischer- | 0 | 0 | |
| | Tropsch unit | | | |
| 65 | Hydrogen feed line to the carbon dioxide | 821 | 8,764 | |
| | compressor | | | |
| 66 | Hydrogen feed line to the refining | 88 | 937 | |
| | unit | | | |
| 67 | Hydrogen feed line to the methanation | 3,200 | 35,560 | |
| | unit | | | |
| 68 | Oxygen line to synthesis gas production | 4,900 | 3,432 | |
| | unit | | | |
| 69 | Oxygen product line | 26,670 | 18,681 | |
| 71 | Feed line for boiler condensates | 106,368 | | 106.6 |
| 72 | Fresh water supply pipe/water discharge | 20,135 | | 20.2 |
| | pipe | | | |
| 73 | Discharge line for boiler feed water | 110,963 | | 111.2 |
| 74 | Discharge line for wastewater | 35,696 | | 35.8 |
| 75 | Discharge line of the water demineralization | 2,500 | | 2.51 |
| | unit | | | |
| 78 | Process water discharge line from | 9,863 | | 9.9 |
| | the Fischer-Tropsch unit | | | |
| 80 | Process water discharge line from | 105 | | 0.11 |
| | refining unit | | | |
| 81 | Process water discharge line from | 264 | | 0.27 |
| | carbon dioxide compression unit | | | |
| 82 | Process water discharge line from | 10,072 | | 10.1 |
| | synthesis gas production unit | | | |
| 83 | Process water discharge line from | 386 | | 0.39 |
| | the separation unit for separating | | | |
| | carbon dioxide | | | |
| 86 | Process water feed line of the evaporation | 11,000 | | 11.0 |
| | unit from the water purification | | | |
| | unit | | | |
| 87 | Process water discharge line of the | 13,172 | | 13.2 |
| | methanation unit | | | |
| 88 | Process water feed line of the water | 22,656 | | 22.7 |
| | demineralization unit from the water | | | |
| | purification unit | | | |

### EXAMPLE 3

The process according to the invention was used in a plant shown in FIG. 3 and described above with the process simulation software PRO/II (AVEVA) for the production of 148,096 liters per day of kerosene (SAF—“Sustainable Aviation Fuel”) and 43,130 liters per day of crude petrol, as well as 13,422 liters per day of light liquid hydrocarbons and 20.6 million liters per day of fuel gas. The following product flows were determined for the individual lines:

| | | | | Liquid |
|---|---|---|---|---|
| | | Total | Gas | Std. |
| No. | Name | kg/h | Nm³/h | m³/h |
| 13 | Methane feed line to the methane | 4,150 | 5,798 | |
| | steam reformer | | | |
| 14 | Methane feed line to the synthesis | 3,400 | 4,750 | |
| | gas production unit | | | |
| 16 | Steam feed line to the synthesis gas | 6,109 | 7,601 | |
| | production unit | | | |
| 18 | Carbon dioxide feed line to the synthesis | 16,090 | 8,204 | |
| | gas production unit | | | |
| 20 | Discharge line for raw synthesis gas | 20,079 | 22,707 | |
| 21 | Discharge line for raw synthesis gas | 9,277 | 23,782 | |
| | from the methane steam reformer | | | |
| 22 | Fuel feed line | 2,974 | 3,622 | |
| 23 | Water (steam) feed line of the methane | 8,000 | 9,953 | |
| | steam reformer | | | |
| 24 | Oxygen-containing gas feed line | 33,639 | 26,108 | |
| 25 | Feed line for combustion air | 32,772 | 25,500 | |
| 26 | Flue gas discharge line | 36,613 | 29,1137 | |
| 27 | Feed line for boiler feed water | 342 | | 0.34 |
| 29 | Raw synthesis gas feed line | 29,357 | 46,489 | |
| 30 | Discharge line for carbon dioxide | 9,669 | 4,886 | |
| | from the raw synthesis gas separation | | | |
| | unit | | | |
| 32 | Discharge line for synthesis gas | 19,688 | 41,481 | |
| 40 | Discharge line for carbon dioxide | 6,645 | 3,448 | |
| | from the flue gas separation unit | | | |
| 41 | Discharge line | 29,968 | 21,720 | |
| 44 | Synthesis gas feed line to the | 19,688 | 41,481 | |
| | Fischer-Tropsch unit | | | |
| 46 | Feed line to the refining unit | 6,317 | | 8.2 |
| 48 | Light hydrocarbons product dis- | 352 | | 0.56 |
| | charge line | | | |
| 48 | Crude petrol product discharge line | 1,231 | | 1.8 |
| 48″ | Kerosene product discharge line | 4,628 | | 6.17 |
| 50 | Gas return line of the Fischer-Tropsch | 3,432 | 4,240 | |
| | unit | | | |
| 51 | Biogas return line to the synthesis | 206 | 203 | |
| | gas production unit | | | |
| 52 | Refining unit gas return line | 88 | 39.4 | |
| 53 | Gas return line for light hydrocarbons | 2,768 | 3,419 | |
| 54 | Fuel return line | 664 | 821 | |
| 55 | Fuel gas discharge line | 752 | 861 | |
| 58 | Water feed line of the electrolysis | 975 | | 0.98 |
| | unit | | | |
| 60 | Oxygen discharge line of the electrolysis | 867 | 608 | |
| | unit | | | |
| 61 | Hydrogen feed line to the methane | 11.5 | 91 | |
| | steam reformer | | | |
| 62 | Hydrogen discharge line of the electrolysis | 108 | 1,097 | |
| | unit | | | |
| 63 | Hydrogen feed line to the synthesis | 9.8 | 78 | |
| | gas production unit | | | |
| 64 | Hydrogen feed line to the Fischer- | 0 | 0 | |
| | Tropsch unit | | | |
| 66 | Hydrogen feed line to the refining | 87 | 927 | |
| | unit | | | |
| 68 | Oxygen line | 867 | 608 | |
| 69 | Oxygen product line | 0 | 0 | |
| 71 | Feed line for boiler condensates | 48,987 | | 49.1 |
| 72 | Fresh water supply pipe/water discharge | 506 | | 0.51 |
| | pipe | | | |
| 73 | Discharge line for boiler feed water | 58,483 | | 58.6 |
| 74 | Discharge line for demineralized water | 975 | | 0.98 |
| 75 | Discharge line for wastewater | 1732 | | 1.74 |
| 78 | Process water discharge line from | 9,938 | | 9.96 |
| | the Fischer-Tropsch unit | | | |
| 80 | Process water discharge line from | 106 | | 0.11 |
| | the refining unit | | | |
| 81 | Process water discharge line from | 224 | | 0.22 |
| | the carbon dioxide compression unit | | | |
| 82 | Process water discharge line from | 5,530 | | 5.54 |
| | the synthesis gas production unit | | | |
| 83 | Process water discharge line from | 342 | | 0.34 |
| | the separation unit for separating | | | |
| | carbon dioxide | | | |
| 85 | Methane steam reformer process | 2,885 | | 2.89 |
| | water feed line | | | |
| 86 | Process water feed line of the evaporation | 6,109 | | 6.12 |
| | unit from the water purification | | | |
| | unit | | | |
| 88 | Process water feed line of the water | 12,709 | | 12.73 |
| | demineralization unit from the water | | | |
| | purification unit | | | |

### LIST OF REFERENCE NUMBERS

10 Plant for the production of synthetic fuels
11 Methanation unit
12 (First) synthesis gas production unit/dry reformer
13 Methane feed line to the methane steam reformer
14 Methane feed line to the synthesis gas production unit
15 Methane feed line
15′ Sub-line into the fuel feed line
16 Steam feed line to the synthesis gas production unit
17 Methane discharge line of the methanation unit
18 Carbon dioxide feed line to the synthesis gas production unit
19 Carbon dioxide feed line to methanation unit
20 Discharge line for raw synthesis gas
21 Discharge line for raw synthesis gas from the methane steam reformer
22 Fuel feed line
23 Methane steam reformer water (steam) feed line
24 Oxygen-containing gas feed line
25 Combustion air feed line
26 Flue gas discharge line
27 Boiler feed water feed line
28 Separation unit for separating carbon dioxide from raw synthesis gas
29 Raw synthesis gas feed line
30 Discharge line for carbon dioxide from the raw synthesis gas separation unit
31 Methane steam reformer (second synthesis gas production unit)
32 Synthesis gas discharge line
34 Fischer-Tropsch unit
36 Refining unit
38 Separation unit for separating carbon dioxide from flue gas
40 Discharge line for carbon dioxide from the flue gas separation unit
41 Nitrogen discharge line
42 Carbon dioxide compression unit
43 Synthesis gas compression unit
44 Synthesis gas feed line to the Fischer-Tropsch unit
46 Feed line to refining unit
48, 48, 48,
50 Gas return line of the Fischer-Tropsch unit
51 Biogas return line to the synthesis gas production unit
52 Refining unit gas return line
53 Gas return line for light hydrocarbons
54 Fuel return line
55 Discharge line for fuel gas
56 Electrolysis unit
58 Water feed line of the electrolysis unit
60 Oxygen discharge line of the electrolysis unit
61 Hydrogen feed line to the methane steam reformer
62 Hydrogen discharge line of the electrolysis unit
63 Hydrogen feed line to the synthesis gas production unit
64 Hydrogen feed line to the Fischer-Tropsch unit
65 Hydrogen feed line to the carbon dioxide compressor
66 Hydrogen feed line to refining unit
67 Hydrogen feed line to the methanator
68 Oxygen line
69 Oxygen product line
70 Water demineralization unit
71 Boiler condensate feed line
72 Fresh water feed line/water discharge line
73 Discharge line for boiler feed water
74 Discharge line for demineralized water
75 Discharge line for wastewater from the plant
76 Water purification unit
78 Process water discharge line from the Fischer-Tropsch unit
80 Process water discharge line from refining unit
81 Process water discharge line from carbon dioxide compression unit
82 Process water discharge line from synthesis gas production unit
83 Process water discharge line from the separation unit for separating carbon dioxide
84 Evaporation unit
85 Methane steam reformer process water feed line
86 Process water feed line to the evaporator from the water purification unit
87 Process water discharge line of the methanation unit
88 Process water feed line of the water demineralization unit from the water purification unit

1. A plant (10) for the production of synthetic fuels, in particular jet turbine fuel (kerosene), crude petrol and/or diesel, comprising:
a) a synthesis gas production unit (12) for the production of a raw synthesis gas comprising carbon monoxide, hydrogen and carbon dioxide from methane, water and carbon dioxide, the synthesis gas production unit (12) having at least one reaction section in which methane, water and carbon dioxide react to form the raw synthesis gas, and at least one heat generation section in which the heat required for the reaction of methane and carbon dioxide to form the raw synthesis gas is generated by burning fuel to form flue gas, the reaction section having a feed line (14) for methane, a feed line (16) for water, at least one feed line (18) for carbon dioxide and a discharge line (20) for raw synthesis gas and the heat generation section having a feed line (22) for fuel, a feed line for oxygen-containing gas (24) and a discharge line (26) for flue gas,
b) a separation unit (28) for separating carbon dioxide from the raw synthesis gas produced in the synthesis gas production unit (12), with a discharge line (30) for carbon dioxide and a discharge line (32) for synthesis gas,
c) a Fischer-Tropsch unit (34) for the production of hydrocarbons by a Fischer-Tropsch process from the synthesis gas from which carbon dioxide has been separated in the separation unit (28), and
d) a refining unit (36) for refining the hydrocarbons produced in the Fischer-Tropsch unit (34) into synthetic fuels,
the plant (10) further comprising:
e ₁₎ a separation unit (38) for separating carbon dioxide from the flue gas discharged via the discharge line (26) for flue gas from the heat generation section of the synthesis gas production unit (12), the separation unit (28) having a discharge line (40) for carbon dioxide, the discharge line (40) for carbon dioxide of the separation unit (38) and the discharge line (30) for carbon dioxide of the separation unit (28) being either connected directly to one of the at least one feed lines (18) for carbon dioxide of the synthesis gas production unit (12) or the discharge line (40) for carbon dioxide of the separation unit (38) and the discharge line (30) for carbon dioxide of the separation unit (28) being connected to a carbon dioxide compression unit (42) which has a discharge line connected to one of the at least one feed lines (18) for carbon dioxide of the synthesis gas production unit (12),
and/or
e ₂₎ a flue gas return line connected to the flue gas discharge line (26) of the synthesis gas production unit (12), the flue gas return line and the carbon dioxide discharge line (30) of the separation unit (28) being connected either directly to one of the at least one carbon dioxide feed lines (18) of the synthesis gas production unit (12) or the flue gas return line and the discharge line (30) for carbon dioxide of the separation unit (28) being connected to a carbon dioxide compression unit (42), which has a discharge line that is connected to one of the at least one feed line (18) for carbon dioxide of the synthesis gas production unit (12), and
wherein the plant (10) further comprises an electrolysis unit (56) for separating water into hydrogen and oxygen, wherein the electrolysis unit (56) has a water feed line (58), an oxygen discharge line (60) and a hydrogen discharge line (62), and, wherein a line (68) leads from the oxygen discharge line (60) into the feed line for oxygen-containing gas (24) to the synthesis gas production unit (12).

2. The plant (10) according to claim 1, characterized in that the synthesis gas production unit (12) also comprises a hydrogen feed line (63) which leads from the hydrogen discharge line (62) of the electrolysis unit to the synthesis gas production unit (12).

3. The plant (10) according to claim 1, characterized in that the synthesis gas production unit (12) is a dry reformer which contains a nickel oxide catalyst and can be operated at a pressure of 10 to 50 bar and a temperature of 700 to 1,200° C.

4. The plant (10) according to claim 1, characterized in that the Fischer-Tropsch unit (34) and/or the refining unit (36) has a gas discharge line (50, 52) which is connected to the fuel feed line (22) of the synthesis gas production unit (12).

5. The plant (10) according to claim 1, characterized in that the refining unit (36) has one or more product discharge lines (48, 48′, 48″) for synthetic fuels, with at least one of the one or more product discharge lines (48, 48′, 48″) for synthetic fuels being connected via a return line (54) to the feed line (22) for fuel of the synthesis gas production unit (12), so that part of the synthetic fuels produced in the refining unit (36) can be fed as fuel into the heat generation section of the synthesis gas production unit (12).

6. The plant (10) according to claim 5, characterized in that it comprises a control unit which controls the quantity of synthetic fuel fed as fuel into the heat generation section of the synthesis gas production unit (12) in such a way that no external fuel has to be supplied to the synthesis gas production unit (12) and preferably to the entire plant (10).

7. The plant (10) according to claim 1, characterized in that from the hydrogen discharge line (62) of the electrolysis unit (56) there is a line (64) to the Fischer-Tropsch unit (34), from the hydrogen discharge line (62) of the electrolysis unit (56) there is a line (66) to the refining unit (36) and from the hydrogen discharge line (62) of the electrolysis unit (56) there is a line (65) to the synthesis gas compression unit (43).

8. The plant (10) according to claim 1, characterized in that it comprises a complete water demineralization unit (70) which has a fresh water feed line (72) and a discharge line (74) for demineralized water, the discharge line (74) for demineralized water being connected to the water feed line of the electrolysis unit (56), with the water demineralization unit (70) preferably comprising one or more anion and cation exchangers and a membrane unit for degassing, which are designed in such a way that water can be demineralized and degassed to such an extent that its conductivity is less than 20 μS/cm, preferably less than 10 μS/cm, particularly preferably less than 5 μS/cm and most preferably at most 2 μS/cm.

9. The plant (10) according to claim 1, characterized in that it comprises a water purification unit (76) which has a water feed line (80) leading from the refining unit (36) to the water purification unit (76) and a water feed line (80) from the Fischer-Tropsch Unit (34), a water feed line (78) leading to the water purification unit (76) and a water feed line (82) leading from the synthesis gas production unit (12) to the water purification unit (76), each for the purification of water accruing therein and preferably also comprises a water feed line (81) leading from the carbon dioxide compression unit (42) to the water purification unit (76), the water purification unit (76) preferably being connected to the water demineralization unit (70) via a line (88), so that the water purified in the water purification unit (76) can be conducted into the water demineralization unit (70).

10. The plant (10) according to claim 9, characterized in that the water purification unit (76) comprises an anaerobic reactor.

11. The plant (10) according to claim 1, characterized in that it has a methane steam reformer (31) as the second synthesis gas production unit (31) for producing a raw synthesis gas comprising hydrogen and carbon monoxide from methane, water and hydrogen, the methane steam reformer (31) has a hydrogen feed line (61), a methane feed line (13), a water (steam) feed line (23), a discharge line (21) for raw synthesis gas and a discharge line (85) for water, the hydrogen feed line (61) being connected to the hydrogen discharge line (62) of the electrolysis unit (56), the discharge line (21) for raw synthesis gas is connected to the discharge line (20) for raw synthesis gas of the synthesis gas production unit (12) and preferably the discharge line (85) for water is connected to the water purification unit (76).

12. The plant (10) according to claim 1, characterized in that the separation unit (28) is followed by a synthesis gas compression unit (43) for compressing the gas to the pressure required in the Fischer-Tropsch synthesis, the synthesis gas compression unit (43) being connected to the separation unit (28) via a line (32) and to the Fischer-Tropsch unit (34) via a synthesis gas feed line (44), the synthesis gas compression unit (43) preferably having a hydrogen feed line (65) which is connected to the electrolysis unit (56).

13. The plant (10) according to claim 1, characterized in that it further comprises a methanation unit (11) for converting carbon dioxide and hydrogen into methane and water, the methanation unit (11) having a carbon dioxide feed line (19), a hydrogen feed line (67) which is connected to the hydrogen discharge line (62) of the electrolysis unit (56), a methane discharge line (17) and a water discharge line (87), the methane discharge line (17) being connected to the methane feed line (14) for the synthesis gas production unit (12), and preferably the water discharge line (85) of the methanation unit (11) being connected to the water purification unit (76).

14. A process for the production of synthetic fuels, in particular jet turbine fuel (kerosene), crude petrol and/or diesel, which is carried out in a plant (10) according to claim 1.

15. The process according to claim 14, characterized in that no carbon dioxide is removed in the process.

16. The process according to claim 14, characterized in that gas produced in the Fischer-Tropsch unit (34), gas produced in the refining unit (36) and part of the synthetic fuels produced in the refining unit are fed as fuel into the heat generation section of the synthesis gas production unit (12), the process being controlled in such a way that no external fuel has to be supplied to the synthesis gas production unit (12) and preferably to the entire plant (10).

17. The process according to claim 14, characterized in that part of the hydrogen generated in the electrolysis unit (56) of the Fischer-Tropsch unit (34), part of the hydrogen generated of the refining unit (36) and part of the hydrogen produced by the electrolysis unit (56) are fed to the synthesis gas production unit (12), the H₂/CO molar ratio in the raw synthesis gas produced in the synthesis gas production unit (12) being controlled so that it is 1.15 to 1.80 and preferably 1.15 to 1.50.

18. The process according to claim 14, characterized in that dry reforming is carried out in the synthesis gas production unit (12), in which a nickel oxide catalyst is used, and the dry reforming is performed at a pressure of 10 to 50 bar and a temperature of 700 to 1,200° C.

19. The process according to claim 14, characterized in that a crude synthesis gas comprising carbon monoxide and hydrogen is produced from methane, water and hydrogen in a methane steam reformer (31), the methane steam reformer (31) receiving water (steam), methane and hydrogen from the electrolysis unit (56) and raw synthesis gas and water are removed from the methane steam reformer (31), the raw synthesis gas being fed to the separation unit (28) and preferably the water being fed to the water purification unit (76), wherein dry reforming is carried out in the synthesis gas production unit (12), the ratio between the dry reformer and the methane steam reformer is adjusted to 30 to 60% to 40 to 65%, based on the methane input, wherein an H₂/CO ratio of 1.13 to 1.80 and preferably 1.15 to 1.50 is set in the raw synthesis gas produced in the dry reformer and in which an H₂/CO ratio of 3.20 to 3.60 is set in the methane steam reformer generated raw synthesis gas.

20. The process according to claim 14, characterized in that carbon dioxide and hydrogen supplied from the electrolysis unit (56) are also converted into methane and water in a methanation unit (11), the methane being fed to the synthesis gas production unit (12) and preferably the water beings fed to the water purification unit (76).
